(19) United States
(12) Patent Application Publication
(10) Pub. No.: US 2011/0037327 A1
(43) Pub. Date: Feb. 17, 2011

(54) LINEAR ELECTROMAGNETIC MACHINES

(76) Inventor: Phillip Raymond Michael Denne, Bournemouth (GB)

Correspondence Address: HAVERSTOCK & OWENS LLP, 162 N WOLFE ROAD, SUNNYVALE, CA, 94086, US

(21) Appl. No.: 12/863,837

(22) PCT Filed: Jan. 23, 2009
(86) PCT No.: PCT/GB2009/000201

§ 371 Date: Nov. 2, 2010

(30) Foreign Application Priority Data
Jan. 24, 2008 (GB) 0801256.9
Feb. 6, 2008 (GB) 0802154.5

(51) Int. Cl. H02K 41/03

(52) U.S. Cl. 310/12.16

(57) ABSTRACT

A linear electromagnetic machine is described which comprises first and second substantially cylindrical parts arranged to move relative to each other along a common axis of motion. The first cylindrical part produces a spatially periodic radial magnetic field across an air gap, the magnetic field having a regular alternating polarity along or parallel to the axis of motion. The second cylindrical part comprises a plurality of laminar electrical conductors wrapped into cylindrical form and placed in the air gap to intercept the magnetic field, each of the laminar electrical conductors compromising a regular pattern of electrically conductive paths, the electrically conductive paths of the plurality of laminar electrical conductors being interdigitated together within the air gap. The use of a plurality of laminar electrical conductors having respective electrically conductive paths which are interdigitated (nested) within the air gap provides for a very thin planar structure which enables the air gap to be made small, thereby improving the efficiency of the electromagnetic machine. In more general terms, improvements relating to the design of low-cost cylindrical or elliptical linear electromagnetic machines are described, in which a conventional assembly of wire coils is replaced by a small number of interdigitated metal laminations.

### FIELD OF INVENTION

The present invention relates to a linear electromagnetic machine, and more particularly to a linear electromagnetic machine having cylindrical magnetic and electrical parts which move relative to each other to provide linear motion.

### BACKGROUND OF THE INVENTION

It is known to construct linear electric motors in cylindrical form in which the output is a rod or tube. It is also known to construct such machines with an armature that is not connected externally but is used as a piston for compression, for controlled expansion (the motor being driven in reverse and acting as a generator) or as an inertial mass, the reaction forces being coupled to the load via the stator.

In such machines the magnetic part generally consists of an array of permanent magnets of disc form that produces a radial magnetic field that is spatially-periodic along the axis of the cylinder. The electrical part of such a linear motor consists of a stack of coils or electrical conductors that surround the armature along the axis of the machine and intersect the spatially-periodic radial magnetic field. The whole unit is generally contained within and bonded to a cylinder of mild steel that also acts as the backing iron by which the magnetic flux may complete its path. Machines of this kind are described in PCT/GB92/01277 and PCT/GB98/00495, for example.

It will be understood that, if the magnetic part is comprised of permanent magnets, there will be a significant magnetostatic force in a radial direction between the magnetic part and the backing iron or steel casing. In the design of such machines it is therefore necessary to ensure that the radial forces are exactly balanced (as far as possible) so as to prevent undue stress on the bearings.

If the continuous rated thrust of a cylindrical machine having a permanent magnet armature is to be increased, it is necessary to make a proportionate increase in the mass of the armature. This is not a simple matter if the core of the armature consists of a stack of disc magnets, because there is a practical limitation on their diameter that is set by the need to sinter the most common form of permanent magnet material under great pressure.

As the unit size of a powerful permanent magnet is increased, it becomes more dangerous to handle during the process of building the motor. It should also be noted that the increased mass of the permanent magnetic material will increase the magnetostatic forces upon the outer casing in direct proportion. It will be understood that it is therefore of increasing importance that the armature moves precisely along the centre line of the machine relative to the backing iron.

Each coil has an axial dimension in the order of a centimetre, so that, if the machine is to have a significant stroke length (several metres) the number of individual coils will be large. All of the coils must be interconnected so as to form complete phase windings and the phases must then be combined in the chosen star or delta configuration. The large number of components and of assembly operations leads to an inherent unreliability.

Further, the completed coil assembly must then be fitted tightly within and be bonded to the cylindrical outer casing (and backing iron) of the machine. There is another difficulty in that the interconnections stand proud of the remainder of the coil assembly and so require a long axial slot to be reamed in the inside surface of the steel outer casing (and a matching slot to be reamed diagonally opposite to it, so as to provide a magnetic balance).

There are few reaming tools capable of producing such slots more than a metre in length.

For these and other reasons it has hitherto been difficult and expensive to produce electromagnetic cylindrical actuators (“rams”) of sufficient thrust and power to meet the demands of industry in its requirement to replace hydraulic machines with equivalent electromagnetic actuators.

### SUMMARY OF INVENTION

According to one aspect of the present invention, there is provided a linear electromagnetic machine comprising first and second substantially cylindrical parts arranged to move relative to each other along a common axis of motion, wherein

the first cylindrical part produces a spatially periodic radial magnetic field across an air gap, the magnetic field having a regular alternating polarity along or parallel to the axis of motion, and

the second cylindrical part comprises a plurality of laminar electrical conductors wrapped into cylindrical form and placed in the air gap to intercept the magnetic field, each of the laminar electrical conductors comprising a regular pattern of electrically conductive paths, the electrically conductive paths of the plurality of laminar electrical conductors being interdigitated within the air gap.

The use of a plurality of laminar electrical conductors having respective electrically conductive paths which are interdigitated (nested) within the air gap provides for a very thin structure which enables the air gap to be made small, thereby improving the efficiency of the electromagnetic machine.

The present invention therefore relates to cylindrical linear electric motors and generators using wireless electrical systems. Wireless electrical machines of a related kind have been described in GB0421593.5, GB0424605.4, GB0503496.2, GB0515313.5 and GB0521577.7, and also in our co-pending Applications GB0617989.9, GB0713408.3, GB0723349.7, PCT/GB2007/003482 and others.

Wireless electrical machines are physically distinguishable from those of conventional construction because the electrical conductors are not placed in slots in the backing iron that are orthogonal to the air gap but instead lie in the air gap and preferably occupy almost the whole surface area of that gap. The electric current flows in patterned conducting paths that are defined by cut-outs in the layers of insulated laminations made from conducting material.

In one embodiment, the plurality of laminar electrical conductors are overlaid, interdigitated and bonded to form an integral mechanical structure. The laminations are stacked in phases and the phases are nested and bonded one within the other in the magnetic field region. They may be arranged to overlap one another outside that region, and may be bonded together to form a self-supporting structure without a dielectric substrate.

The pattern of electrically conducting paths formed in the laminar conductors may comprise transverse conducting paths provided circumferentially about the cylindrical form, and axial conducting paths provided axially along the cylindrical form, the transverse conducting paths being interdigitated to form a cylindrical surface within the air gap.

The spatially periodic radial magnetic field may be produced by permanently-magnetised material. The permanently-magnetised magnetic material may be formed from a number of individual pre-magnetised segments, the individual pre-magnetised segments being abutted and mounted between ring-shaped pole pieces. Furthermore, the ring-shaped pole pieces may be tapered radially, so as to inhibit flux leakage in a direction other than through the electrical conductors.

Alternatively, the spatially periodic magnetic field may be produced by wire coils or further patterned laminar electrical conductors through which electric currents are caused to flow.

Alternatively, the spatially-periodic magnetic field may be induced by temporal variation of the currents in the laminar electrical conductors of the second cylindrical or elliptical part.

The laminar electrical conductors may be made from insulated patterned metallic sheet, strip, ribbon or foil.

The laminar electrical conductors of the second cylindrical or elliptical part may be connected in a plurality of phases, through which separate electrical currents are arranged to pass, the relative signs and amplitudes of the currents being controlled so as to determine the magnitude and sign of the electromagnetic force produced by the machine.

For example, a linear electromagnetic machine having a three-phase operation can be provided. The patterns of electrically conducting paths formed in the laminar conductors of each phase may then include conducting paths which are transverse the force vector and which have a regular axial dimension that is approximately equal to but less than one sixth of the length of the period of the axially periodic magnetic field and which cause the current to flow alternately back and forth transverse the line of the force vector with a spatial period equal to one half of the magnetic period. The conducting paths of each phase are arranged to lie closely adjacent those of the other two phases in the region of the spatially-periodic magnetic field and to overlap them elsewhere.

The magnetic field may be produced by the armature and the laminar electrical conductors may form or be incorporated within the stator. Alternatively, the magnetic field may be produced by the stator and the laminar electrical conductors may form or be incorporated within the armature.

The armature may be arranged to move through or along at least one bearing affixed or forming part of the stator. In this case, at least one end of the machine may have an aperture and carry a bearing through which is extended a thrust tube or rod by which the force on the armature may be transmitted externally.

The laminar electrical conductors may form part of the stator and be fabricated and affixed as separate sectors along the line of motion of the armature. They may be independently powered and controlled.

A linear electromagnetic machine may be provided in which there is no fin or rod extended so as to connect to an internal armature, but in which the load is connected to the stator and thereby receives the whole or part of the reaction forces corresponding with the accelerations of the unconnected armature.

The laminar electrical conductors of the second part may be insulated and be made to conform to the shape of a precision mandrel. The linear electromagnetic machine may have an external surface to which axially-orientated iron wires, strips or cylindrical segments are affixed to provide a backing iron and a path for outward heat transfer.

In another embodiment, at least one of the laminar electrical conductors may be fabricated from ferromagnetic material.

The linear electromagnetic machine may comprise a containing cylinder which houses the first and second cylindrical parts and which is hermetically sealed. The thrust rod or tube may be arranged to pass through a sliding seal to emerge from the containing cylinder, such that the armature has both an electrical and a fluid actuation function. The thrust rod or tube may form the active element of a gas spring. The movement of the armature may also be arranged to propel or to be propelled by fluid within the containing cylinder, so as to function as a pump or to absorb energy from a moving fluid.

Embodiments of the invention seek to provide an economical means of constructing a cylindrical linear electrical machine in which the limitations on the diameter and mass of the magnetic armature are overcome so that large thrusts and continuous power outputs may be produced if required.

Embodiments of the invention seek to ensure that the backing iron remains equidistant from the central axis, that the air gap distance is minimised and that the magnetostatic forces are radially balanced.

Embodiments of the invention seek to provide an economical means of building a cylindrical linear electrical machine in which the cost and complexity of the machine does not increase rapidly with stroke length.

The wireless electrical part of the cylindrical linear actuator may consist in an assembly of patterned laminations of a conducting material (such as aluminium) that is wrapped around a central dielectric cylinder in which the magnetic armature is constrained to move. It will be understood that, because each lamination has a large area and replaces many individual coils and their interconnections by a single component, the use of the wireless technology increases the reliability of the actuator and reduces the cost of the electrical part of the stator, thus preventing the cost of the electrical stator from being strongly dependent upon its length.

The electrical laminations may be laid upon and bonded to a thin carbon fibre sleeve upon a precision mandrel. The backing iron may not be a complete cylinder into which the electrical assembly must be fitted and bonded but may instead be constructed from a number of straight pieces of iron that are orientated parallel to the machine axis and packed together around the conducting laminations to form a cylindrical shell. The fabricated shell may be bonded to the outer surface of the laminations and at a later stage the complete assembly fitted within the outermost casing of the actuator (which may be made from any convenient material). Resin may then be introduced under vacuum between the packed iron and the casing to complete the structure and to provide a thermal conducting medium.

Thus the final assembly no longer suffers a tight constraint on the positioning of the electrical assembly in relation to the backing iron, since the backing iron is now part of the electrical assembly itself and is in good thermal contact with the electrical conductors.

It will be understood that the principles of this invention may be applied to machines in which power is supplied to the armature and in which electromagnets are used in place of permanent magnets.

Embodiments of the present invention may also be applied to induction machines wherein the array of permanent magnets is replaced with a simple cylinder of electrical conducting material, or consists in a passive arrangement of patterned conductive laminations. In such induction machines a travelling magnetic field is produced by phased alternating currents in the powered conductors and eddy currents are thereby induced in the passive conductor array. The interaction of the induced currents and the controlled alternating currents produces an axial force. Although the resulting axial force is smaller than that produced by a machine using permanent magnetic fields or using fields produced by electromagnets, an induction machine is low in cost and light in weight and it may therefore offer a significant advantage in some circumstances. Most electric motors are induction machines.

It will also be understood that the method of construction of the stator is the same, whether the armature uses permanent magnets or electromagnets or whether it is replaced by a cylindrical conductor, so as to construct an induction motor.

It will be further understood that the principles of the invention may be applied to conducting laminations made of ferrous material such as iron or steel. In this case the machine losses will be greater than those for a machine with (e.g.) aluminium conductors. Nevertheless, there may be a significant benefit in some applications because the reluctance of the air gap will be considerably reduced, so that less magnetic material will be needed.

In one embodiment, at least one of the laminar electrical conductors may comprise or support a layer of material which, when cooled below its critical temperature, becomes superconducting. By using a conducting material that consists in or is coated with a layer of superconducting material, resistive losses may be entirely eliminated and much higher current densities can be used to produce a large force in a small space.

It will also be understood that the principles of this invention, though here described in relation to a cylindrical structure, apply also to a structure having an elliptical cross section.

When acting passively, being driven by external forces, a machine according to this invention may act as an electrical generator and may also, for example, be used as a controllable damper.

Various other aspect and features of the present invention are defined in the claims.

### BRIEF DESCRIPTION OF THE DRAWINGS

Embodiments of the invention will now be described, by way of example only, with reference to the accompanying drawings in which:

FIG. 1 schematically illustrates a magnetic part of a linear electromagnetic machine formed from magnetic segments;

FIG. 2 schematically illustrates a magnetic force unit formed from magnetic segments and ring-shaped pole pieces;

FIG. 3 schematically illustrates an armature array formed by stacking the magnetic force units shown in FIG. 2;

FIG. 4 schematically illustrates a laminated electrical conductor;

FIG. 5 schematically illustrates the laminated electrical conductor of FIG. 4 wrapped into cylindrical form;

FIG. 6 schematically illustrates an example cylindrical stator;

FIG. 7 schematically illustrates the cylindrical stator of FIG. 6 with backing iron strips; and

FIG. 8 schematically illustrates an electromagnetic machine according to an embodiment of the present invention.

### DESCRIPTION OF EXAMPLE EMBODIMENTS

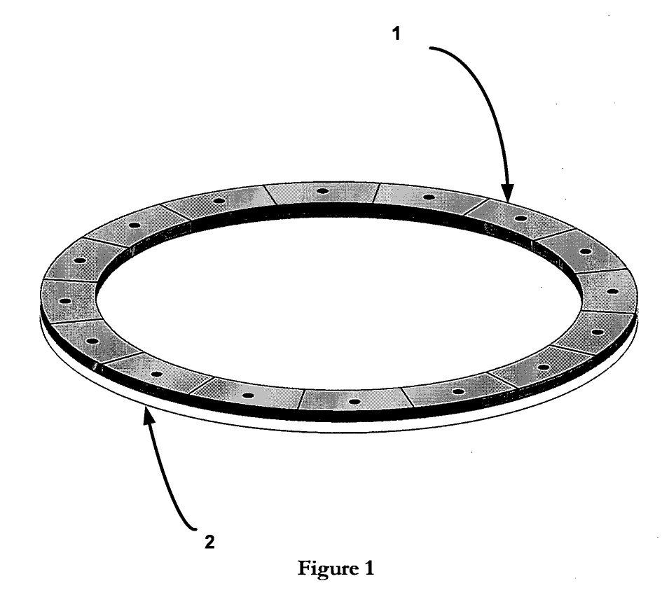

Referring to FIG. 1, a plurality of separate magnetic segments 1 are shown to be provided, and are pinned and bonded to a lower pole piece 2.

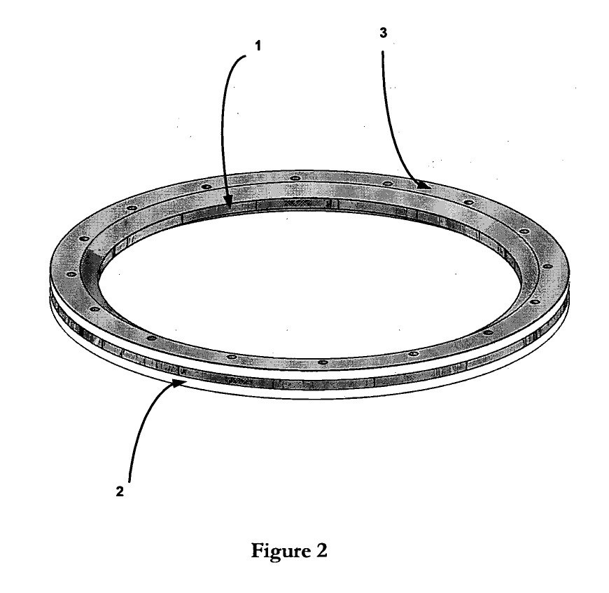

FIG. 2 shows how an upper pole piece ring 3 is fitted to the array of magnetic segments 1, so as to produce a complete force unit. The inwards taper of the rings (which reduces the leakage flux) is clearly visible in the diagram.

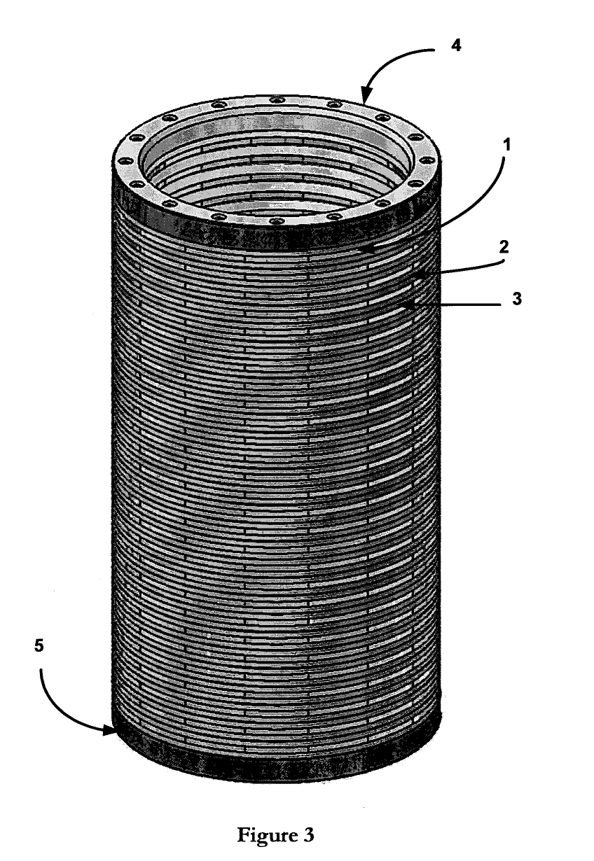

FIG. 3 shows how the required number of force units (having components 1, 2 and 3 as previously described with reference to FIGS. 1 and 2) are stacked with like poles opposing and are clamped between two non-magnetic end pieces 4 and 5, so as to form a complete armature array.

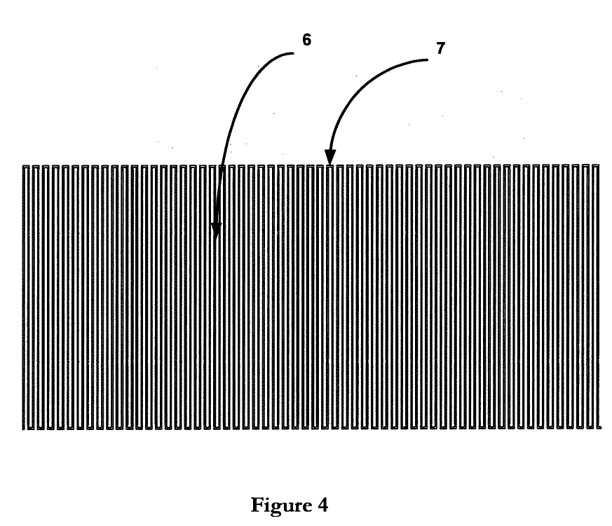

FIG. 4 shows a typical conductor lamination as first manufactured from a metal sheet, having transverse conducting paths 6, connected by axial conducting paths 7. The axial conducting paths 7 may be considered to be equivalent to the end windings of a conventional coil-wound electrical machine.

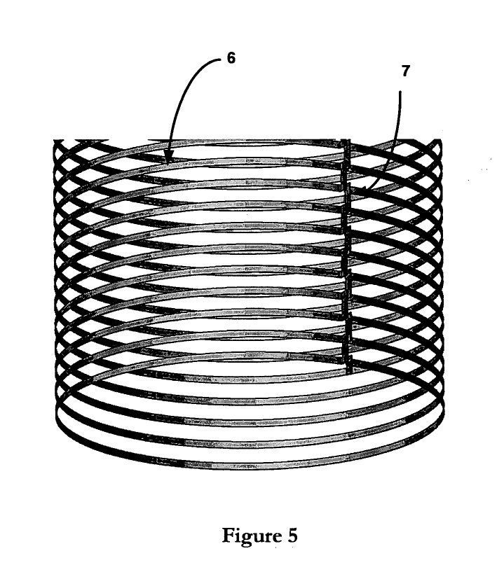

FIG. 5 shows how the conductor lamination (in this case part of the stator assembly) is wrapped into cylindrical form. The transverse conducting paths 6 lie circumferentially and the connecting conducting paths 7 are arranged to lie axially. It will be understood that the conducting lamination may actually be rolled upon and bonded to the outer surface of a thin carbon fibre sleeve, the sleeve itself being fitted to a precision mandrel. It will also be noted that the ends of the transverse conducting paths 6 are bent outwards so that the conducting paths 7 stand clear of the paths 6.

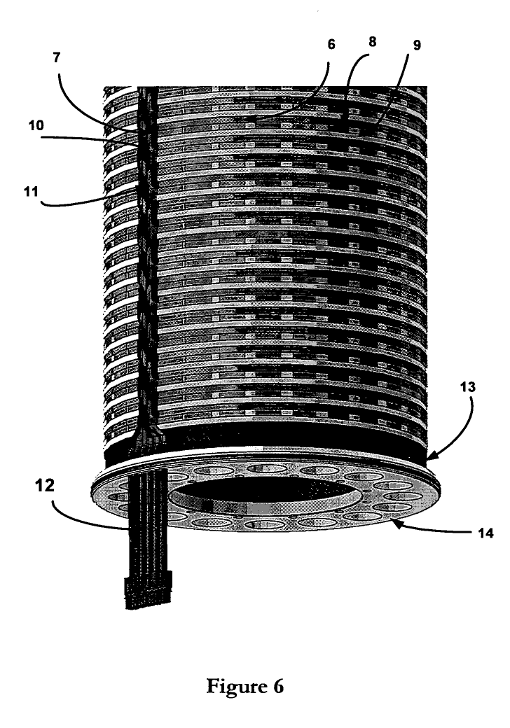

FIG. 6 shows a part of the completed cylindrical stator of the example machine. Two other sets of patterned conducting laminations 8, 9 comprise the second and third phases of the electrical system and they are nested with the first lamination 6. The connecting paths (or “end windings”) 10, 11 of the phases 8, 9 are arranged to lie parallel to the connecting paths 7. The three phases are carefully insulated one from another and the ends of the phases are brought out to connecting terminals 12. FIG. 6 shows the thin carbon fibre sleeve 13 onto which the laminations are formed and bonded. One of the end pieces of the stator assembly 14 is also shown here.

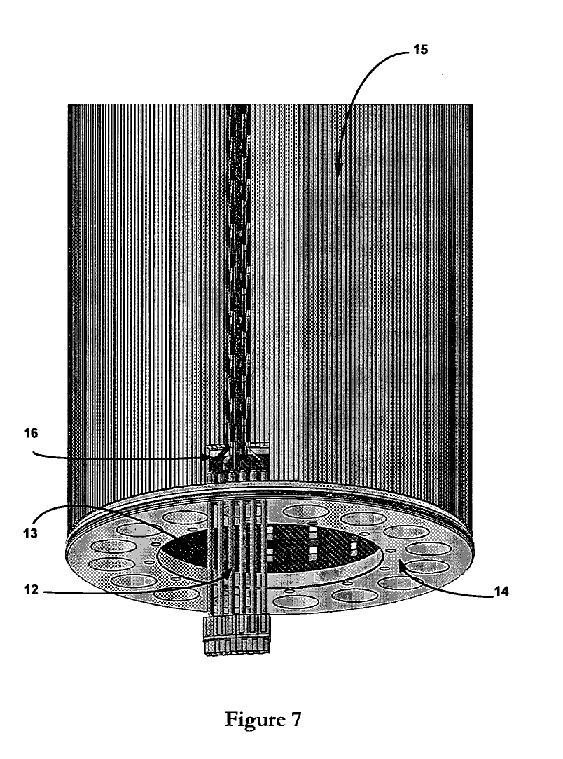

FIG. 7 shows the assembly of FIG. 6 at a later stage, with backing iron strips 15 packed upon and bonded to the outer surface of the conducting laminations (though insulated therefrom). It should be noted that the backing iron strips 15 are omitted from the region of the axial connecting paths of the laminations and that the strips that are close to the connectors in the region 16 are shorter than the others. It will be understood that there is a corresponding gap in the iron 15 diagonally opposite to that shown, so as to maintain a magnetostatic balance across the axis of the machine.

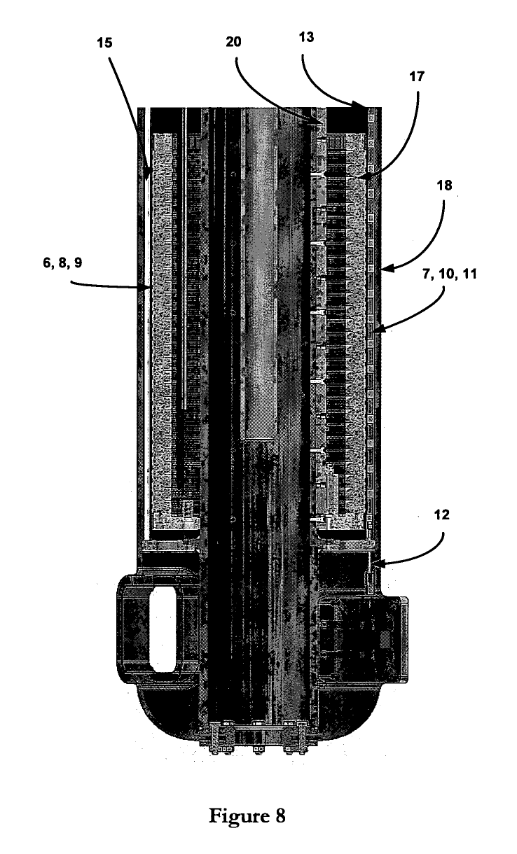

FIG. 8 shows how a magnetic armature 17 is mounted to an output thrust tube 20 and is free to move within the sleeve 13 that forms the inner surface of the stator assembly. The stator is fitted within and bonded to an outer casing 18, which may be made of any suitable material, such as glass fibre, aluminium or steel. The left hand side of the drawing shows a section through the transverse conducting paths 6, 8, 9 surrounded by the backing iron strips 15, whilst the right hand side of the drawing shows how the axial elements 7, 10, 11 fit within a space in the backing iron and connect with the terminations 12.

The principal advantages provided by embodiments of the present invention include the following:
By the use of ring-shaped, tapered pole pieces fitted with pre-magnetised segments, the diameter of the armature and the mass of magnetic material can be increased without limitation, so as to enhance the continuously-rated thrust of a linear actuator.
The mass of the electrical part of such a machine may be reduced by the replacement of copper wire by laminar aluminium conductors.
At present material prices, the cost of the conducting material may be reduced by an order of magnitude
The manufacturing cost may be greatly reduced by eliminating the work of winding and assembling a large number of coils and of bonding them into the mechanical structure.
The manufacturing quality and the operational reliability of the machine may be increased by the corresponding reduction in complexity.
Because the rate of heat flow from a flat surface is greater than that from a wire bundle, the machine can be driven harder than a conventional coil-wound machine.
The aluminium conductors may be insulated by an anodising process, which is simple and provides a robust insulating coating that will withstand high temperature operation if necessary.
The construction of the backing iron, from a number of individual strips lying axially, prevents eddy current losses that would otherwise tend to flow circumferentially in a solid cylindrical casing.
The construction of the backing iron, from a number of individual strips laid axially and bonded to the stator conductors upon a mandrel precisely defines the air gap distance.
It is possible for the electrical system to be manufactured and transported in sections, so that a very large motor may be assembled on site without undue difficulty.
The rod or tube output element of such a machine may be sealed to act as part of a gas spring subsystem that supports a deadload whilst the electromagnetic system provides the dynamic forces.
Such a sealed machine may also function as a fluid pump or as a mechanism by which fluid energy may be efficiently converted to electrical energy, the wireless motor being driven in reverse.
The technology is fully scaleable and may be applied to electrical machines having a wide range of sizes and power outputs.

Various further aspects and features of the present invention are defined in the appended claims. Various modifications can be made to the embodiments herein before described without departing from the scope of the present invention.

1. A linear electromagnetic machine comprising first and second substantially cylindrical or elliptical parts arranged to move relative to each other along a common axis of motion, wherein
the first cylindrical or elliptical part produces a spatially periodic radial magnetic field across an air gap, the magnetic field having a regular alternating polarity along or parallel to the axis of motion, and
the second cylindrical or elliptical part comprises a plurality of laminar electrical conductors wrapped into cylindrical or elliptical form and placed in the air gap to intercept the magnetic field, each of the laminar electrical conductors comprising a regular pattern of electrically conductive paths, the electrically conductive paths of the plurality of laminar electrical conductors being interdigitated within the air gap;
wherein the patterns of electrically conducting paths formed in each of the laminar conductors include conducting paths transverse the force vector and having a regular spatial dimension that is substantially equal to but less than one sixth of the length of the period of the spatially periodic magnetic field and which cause the current to flow alternately back and forth transverse the line of the force vector with a spatial period equal to one half of the magnetic period, the conducting paths of each laminar electrical conductor being arranged to lie closely adjacent those of the other laminar electrical conductors in the region of the spatially-periodic magnetic field and to overlap them elsewhere.

2. A linear electromagnetic machine according to claim 1, wherein the plurality of laminar electrical conductors are overlaid, interdigitated and bonded to form an integral mechanical structure.

3. A linear electromagnetic machine according to claim 1, wherein the spatially periodic radial magnetic field is produced by permanently-magnetised material.

4. A linear electromagnetic machine according to claim 3, wherein the permanently-magnetised magnetic material is formed from a number of individual pre-magnetised segments, the individual pre-magnetised segments being abutted and mounted between ring-shaped pole pieces.

5. A linear electromagnetic machine according to claim 4, wherein the ring-shaped pole pieces are tapered radially, so as to inhibit flux leakage in a direction other than through the electrical conductors.

6. A linear electromagnetic machine according to claim 1, wherein the spatially periodic magnetic field is produced by wire coils or further patterned laminar electrical conductors through which electric currents are caused to flow.

7. A linear electromagnetic machine according to claim 1, wherein the spatially-periodic magnetic field is induced by temporal variation of the currents in the laminar electrical conductors of the second cylindrical or elliptical part.

8. A linear electromagnetic machine according to claim 1, wherein at least one of the laminar electrical conductors is made from insulated patterned metallic sheet, strip, ribbon or foil.

9. A linear electromagnetic machine according to claim 1, wherein the pattern of electrically conducting paths formed in the laminar conductors comprise transverse conducting paths provided circumferentially about the cylindrical form, and axial conducting paths provided axially along the cylindrical form, the transverse conducting paths being interdigitated to form a cylindrical surface within the air gap.

10. A linear electromagnetic machine according to claim 1, wherein the laminar electrical conductors of the second cylindrical or elliptical part are connected in a plurality of phases, through which separate electrical currents are arranged to pass, the relative signs and amplitudes of the currents being controlled so as to determine the magnitude and sign of the electromagnetic force produced by the machine.

11. A linear electromagnetic machine according to claim 10, wherein the machine provides three-phase operation.

12. A linear electromagnetic machine according to claim 1, wherein the magnetic field is produced by the armature and the laminar electrical conductors form are incorporated within the stator.

13. A linear electromagnetic machine according to claim 1, wherein the magnetic field is produced by the stator and the laminar electrical conductors form or are incorporated within the armature.

14. A linear electromagnetic machine according to claim 1, wherein the armature is arranged to move through or along at least one bearing affixed or forming part of the stator.

15. A linear electromagnetic machine according to claim 14, wherein at least one end of the machine has an aperture and carries a bearing through which is extended a thrust tube or rod by which the force on the armature may be transmitted externally.

16. A linear electromagnetic machine according to claim 1, wherein the laminar electrical conductors form part of the stator and are fabricated and affixed as separate sectors along the line of motion of the armature and are independently powered and controlled.

17. A linear electromagnetic machine according to claim 1, wherein the load is connected to the stator and thereby receives the whole or part of the reaction forces corresponding with the accelerations of the unconnected armature.

18. A linear electromagnetic machine according to claim 1, wherein the laminar electrical conductors of the second part are insulated and are made to conform to the shape of a precision mandrel.

19. A linear electromagnetic machine according to claim 18, having an external surface to which axially-orientated iron wires, strips or cylindrical segments are affixed to provide a backing iron and a path for outward heat transfer.

20. A machine constructed in accordance with claim 1, wherein at least one of the laminar electrical conductors comprises or supports a layer of material which, when cooled below its critical temperature, becomes superconducting.

21. A linear electromagnetic machine according to claim 1, wherein at least one of the laminar electrical conductors in the whole or in part is fabricated from ferromagnetic material.

22. A linear electromagnetic machine according to claim 15, comprising a containing cylinder which houses the first and second cylindrical parts and is hermetically sealed, wherein the thrust rod or tube is arranged to pass through a sliding seal to emerge from the containing cylinder, such that the armature has both an electrical and a fluid actuation function.

23. A linear electromagnetic machine according to claim 22, wherein the thrust rod or tube forms the active element of a gas spring.

24. A linear electromagnetic machine according to claim 22, wherein the movement of the armature is arranged to propel or to be propelled by fluid within the containing cylinder, so as to function as a pump or to absorb energy from a moving fluid.
